(19) United States
(12) Patent Application Publication
(10) Pub. No.: US 2026/0003048 A1
(43) Pub. Date: Jan. 1, 2026

(54) DRIVING DEVICE, SIGNAL PROCESSING DEVICE, ULTRASONIC SENSOR, AND VEHICLE

(71) Applicant: ROHM CO., LTD., Kyoto-shi (JP)

(72) Inventor: Koji SAITO, Kyoto-shi (JP)

(21) Appl. No.: 19/320,710

(22) Filed: Sep. 5, 2025

Related U.S. Application Data
(63) Continuation of application No. PCT/JP2024/001139, filed on Jan. 17, 2024.

(30) Foreign Application Priority Data
Mar. 10, 2023 (JP) 2023-037446

(51) Int. Cl. G01S 7/534; G01S 7/536; G01S 15/931

(52) U.S. Cl. CPC G01S 7/534; G01S 15/931; G01S 7/536

(57) ABSTRACT

A driving device includes a transmission wave signal generation circuit configured to generate a transmission wave signal, and a driving circuit configured to drive an ultrasonic oscillation element based on the transmission wave signal. The driving circuit has an initial driving sequence in which the driving circuit generates the transmission wave signal at an initial frequency, a first transition sequence in which the driving circuit generates the transmission wave signal during its transition from the initial frequency to a first frequency, and a second transition sequence in which the driving circuit generates the transmission wave signal during its transition from the first frequency to a second frequency. The initial frequency and the second frequency are closer than the first frequency, to the resonance frequency of the ultrasonic oscillation element. The first transition sequence is allotted a longer time than the time allotted to the second transition sequence.

### CROSS REFERENCE TO RELATED APPLICATIONS

This application is a continuation under 35 U.S.C. §120 of Application No. PCT/JP2024/001139 filed on January 17, 2022, which is incorporated herein by reference, and which claims priority Japanese Patent Application No. 2023-037446 filed on March 10, 2023. The present application likewise claims priority under 35 U.S.C. §119 to Japanese Application No. 2023-037446 filed March 10, 2023, the entire content of which is also incorporated herein by reference.

### BACKGROUND OF THE INVENTION

### Technical Field

The invention disclosed in the present description relates to driving devices, signal processing devices, ultrasonic sensors, and vehicles.

### Description of Related Art

An ultrasonic sensor generates an ultrasonic wave and measures the time that the so generated ultrasonic wave takes to strike an object and returns to the ultrasonic sensor. Based on the measured time the ultrasonic sensor finds the distance from the ultrasonic sensor to the object.

### BRIEF DESCRIPTION OF DRAWINGS

FIG. 1 is a diagram showing an outline of the configuration of an ultrasonic sensor according to an embodiment.

FIG. 2 is a diagram showing a waveform of a driving signal and the frequency transition of a transmission wave signal.

FIG. 3 is a diagram showing another waveform of a driving signal and the frequency transition of a transmission wave signal.

FIG. 4 is a diagram showing a first pattern of the frequency transition of a transmission wave signal and an ultrasonic wave.

FIG. 5 is a diagram showing a second pattern of the frequency transition of a transmission wave signal and an ultrasonic wave.

FIG. 6 is a diagram showing a third pattern of the frequency transition of a transmission wave signal and an ultrasonic wave.

FIG. 7 is a diagram showing a fourth pattern of the frequency transition of a transmission wave signal and an ultrasonic wave.

FIG. 8 is a diagram showing a fifth pattern of the frequency transition of a transmission wave signal and an ultrasonic wave.

FIG. 9 is an exterior view of a vehicle.

### DESCRIPTION OF EMBODIMENTS

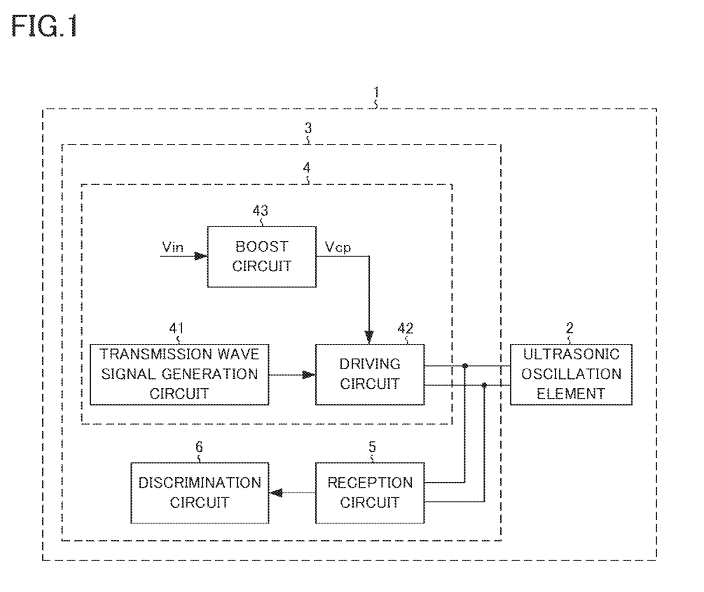

FIG. 1 is a diagram showing an outline of the configuration of an ultrasonic sensor 1 according to an embodiment. The ultrasonic sensor 1 includes an ultrasonic oscillation element 2 and a signal processing device 3.

The ultrasonic oscillation element 2 is configured with a piezoelectric element; it emits an ultrasonic wave and receives the ultrasonic wave reflected from an object (a reflection wave from the object). That is, the ultrasonic oscillation element 2 is an ultrasonic wave transmission/reception device that transmits and receives a ultrasonic wave. As a modification to the embodiment, the ultrasonic sensor can be configured to have an ultrasonic oscillation element dedicated to the transmission of an ultrasonic wave and an ultrasonic oscillation element dedicated to the reception of an ultrasonic wave.

The signal processing device 3 processes a driving signal to be fed to the ultrasonic oscillation element 2 and a signal received from the ultrasonic oscillation element 2. In the embodiment, no transformer is provided between the ultrasonic oscillation element 2 and the signal processing device 3.

The signal processing device 3 includes a driving device 4, a reception circuit 5, and a discrimination circuit 6.

The driving device 4 drives the ultrasonic oscillation element 2. The driving device 4 includes a transmission wave signal generation circuit 41, a driving circuit 42, and a boost circuit 43.

The transmission wave signal generation circuit 41 generates a transmission wave signal. The transmission wave signal generation circuit 41 has a plurality of frequency variation patterns and selects one of those frequency variation patterns.

The driving circuit 42 feeds the ultrasonic oscillation element 2 with a driving signal produced by amplifying the transmission wave signal and thereby drives the ultrasonic oscillation element 2 (makes it oscillate).

The boost circuit 43 boosts (steps up) a voltage Vin fed to it and thereby generates a supply voltage Vcp for the driving circuit 42. The boost circuit 43 is configured as, for example, a charge pump circuit. A long driving duration for the ultrasonic oscillation element 2 causes a drop in the supply voltage Vcp and hence a drop in the power of the ultrasonic wave emitted from the ultrasonic oscillation element 2. So, in an ultrasonic sensor 1 provided with no transformer, a short driving duration for the ultrasonic oscillation element is particularly beneficial.

The reception circuit 5 receives the signal output from the ultrasonic oscillation element 2 and generates a reception signal based on the reflection wave from the object.

The discrimination circuit 6 discriminates the frequency variation pattern selected by the transmission wave signal generation circuit 41 from the frequency variation patterns not selected by the transmission wave signal generation circuit 41, and thereby discriminates the reflection wave. That is, if the frequency variation pattern of the reception signal fed from the reception circuit 5 corresponds to (is identical with or similar to) the frequency variation pattern selected by the transmission wave signal generation circuit 41, the discrimination circuit 6 discriminates (detects) the reflection wave. The discrimination in the discrimination circuit 6 allows distinction, from an ultrasonic wave emitted from another ultrasonic sensor, of the ultrasonic wave (reflection wave) emitted from the ultrasonic sensor 1 itself and returning by being reflected from the object.

The plurality of frequency variation patterns provided in the transmission wave signal generation circuit 41 include a pattern in which transitions occur in the order of an initial frequency f0, a first frequency fl, and a second frequency f2. The driving circuit 42 has an initial driving sequence in which it generates the transmission wave signal at the initial frequency f0, a first transition sequence in which it generates the transmission wave signal during its transition from the initial frequency f0 to the first frequency fl, and a second transition sequence in which it generates the transmission wave signal during its transition from the first frequency fl to the second frequency f2. If the transmission wave signal generation circuit 41 selects the pattern in which transitions occur in the order of the initial frequency f0, the first frequency fl, and the second frequency f2, the driving circuit 42 executes the initial driving sequence, the first transition sequence, and the second transition sequence. Here, the initial frequency f0 and the second frequency f2 are closer, than the first frequency fl, to the resonance frequency fc of the ultrasonic oscillation element 2.

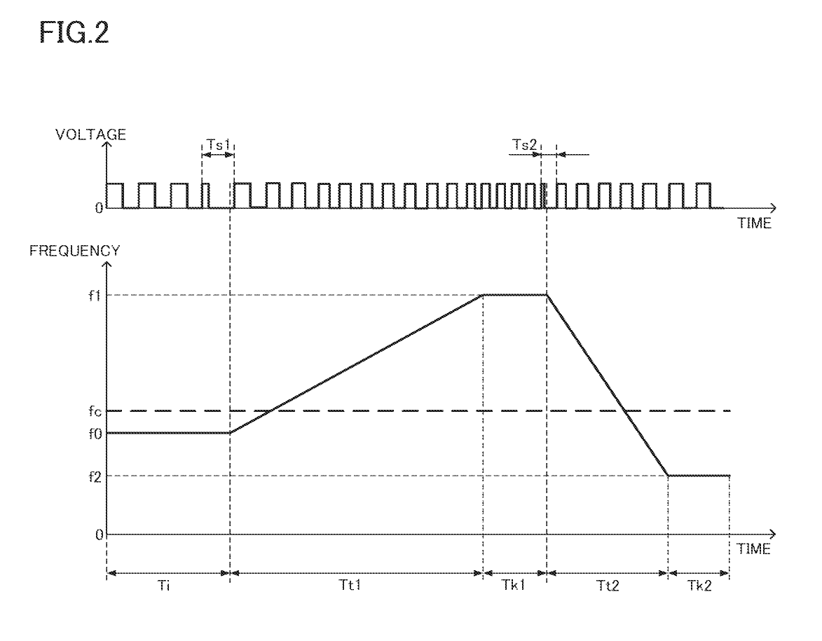

FIG. 2 is a diagram showing the waveform of the driving signal and the frequency transition of the transmission wave signal as observed if the transmission wave signal generation circuit 41 selects the pattern in which transitions occur in the order of the initial frequency f0, the first frequency fl, and the second frequency f2.

FIG. 2 depicts, from top down, the waveform of the driving signal and the frequency transition of the transmission wave signal. For the waveform of the driving signal, the horizontal axis represents time and the vertical axis represents voltage. For the frequency transition of the transmission wave signal, the horizontal axis represents time and the vertical axis represents frequency.

The driving circuit 42 allots the first transition sequence a time Ttl longer than the time Tt2 it allots to the second transition sequence. The driving circuit 42 allots the initial driving sequence as long a time Ti as is needed for the oscillation of the ultrasonic oscillation element 2 to stabilize at the initial frequency f0.

The ultrasonic oscillation element 2 is structured to be easy to oscillate at the resonance frequency fc. Accordingly, when the frequency of the transmission wave signal is changed from a value close to the resonance frequency fc to a value far from the resonance frequency fc, the oscillation frequency of the ultrasonic oscillation element 2 does not readily follow the change of the transmission wave signal. To cope with this, the driving circuit 42 allots the first transition sequence a longer time Ttl as described above for more improvingly response of the change of the oscillation frequency of the ultrasonic oscillation element 2 to the change of the transmission wave signal in the first transition sequence. On the other hand, when the frequency of the transmission wave signal is changed from a value far from the resonance frequency fc to a value close to the resonance frequency fc, the oscillation frequency of the ultrasonic oscillation element 2 easily follows the change of the transmission wave signal. Accordingly, the driving circuit 42 allots the second transition sequence a shorter time Tt2 as described above to prevent a long driving duration for the ultrasonic oscillation element.

Thus the driving device 4 can, while preventing the ultrasonic oscillation element 2 from being driven for a long duration, improve the response of the change of the oscillation frequency of the ultrasonic oscillation element 2 to the change of the frequency of the transmission wave signal. In this way, even with a short driving duration for the ultrasonic oscillation element 2, it is possible to improve the accuracy of the discrimination of the reflection wave by the discrimination circuit 6.

In the frequency transition of the transmission wave signal shown in FIG. 2, the first frequency fl is higher than the second frequency f2; instead, the second frequency f2 can be higher than the first frequency fl. In the frequency transition of the transmission wave signal shown in FIG. 2, the initial frequency f0 is lower than the resonance frequency fc of the ultrasonic oscillation element 2; instead, the initial frequency f0 can be higher than the resonance frequency fc of the ultrasonic oscillation element 2, or the initial frequency f0 can be equal to the resonance frequency fc of the ultrasonic oscillation element 2. In the frequency transition of the transmission wave signal shown in FIG. 2, the second frequency f2 differs from the initial frequency f0; instead the second frequency f2 can be equal to the initial frequency f0.

As shown in FIG. 2, the driving circuit 42 can further have a first retention sequence in which it keeps generating the transmission wave signal at the first frequency fl, with the time Tkl for the first retention sequence secured between the time Ttl for the first transition sequence and the time Tt2 for the second transition sequence. The driving circuit 42 does not necessarily need to have the first retention sequence.

As shown in FIG. 2, the driving circuit 42 can further have a second retention sequence in which it keeps generating the transmission wave signal at the second frequency f2, with the time Tk2 for the second retention sequence secured after the time Tt2 for the second transition sequence. The driving circuit 42 does not necessarily need to have the second retention sequence.

Preferably, as shown in FIG. 2, immediately before starting the first transition sequence, the driving circuit 42 reduces the driving power. In the example shown in FIG. 2, immediately before starting the first transition sequence, the driving circuit 42 starts a period Tsl in which it reduces the duty of the driving signal fed to the ultrasonic oscillation element 2. Thus, the frequency transition starts with the ultrasonic oscillation element 2 momentarily powered down. This smoothens the change of the frequency of the ultrasonic oscillation element 2. It is thus possible to further improve the response of the change of the oscillation frequency of the ultrasonic oscillation element 2 to the change of the frequency of the transmission wave signal.

As shown in FIG. 2, preferably, immediately before starting the second transition sequence, the driving circuit 42 reduces the driving power. In the example shown in FIG. 2, immediately before starting the second transition sequence, the driving circuit 42 starts a period Ts2 in which it reduces the duty of the driving signal fed to the ultrasonic oscillation element 2. Thus, the frequency transition starts with the ultrasonic oscillation element 2 momentarily powered down. This smoothens the change of the frequency of the ultrasonic oscillation element 2. It is thus possible to further improve the response of the change of the oscillation frequency of the ultrasonic oscillation element 2 to the change of the frequency of the transmission wave signal.

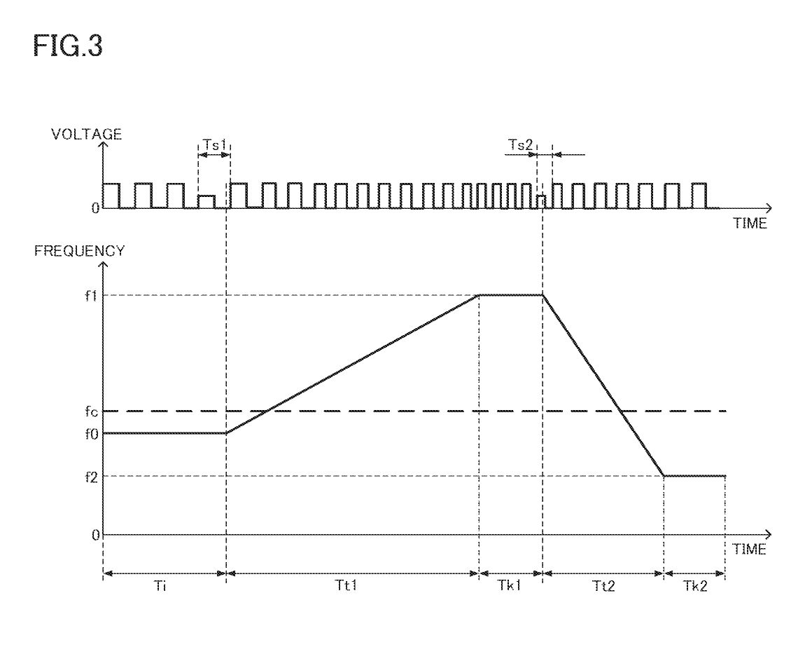

It is also possible, as in the example shown in FIG. 3, to reduce the driving power by reducing the amplitude of the driving signal fed to the ultrasonic oscillation element 2.

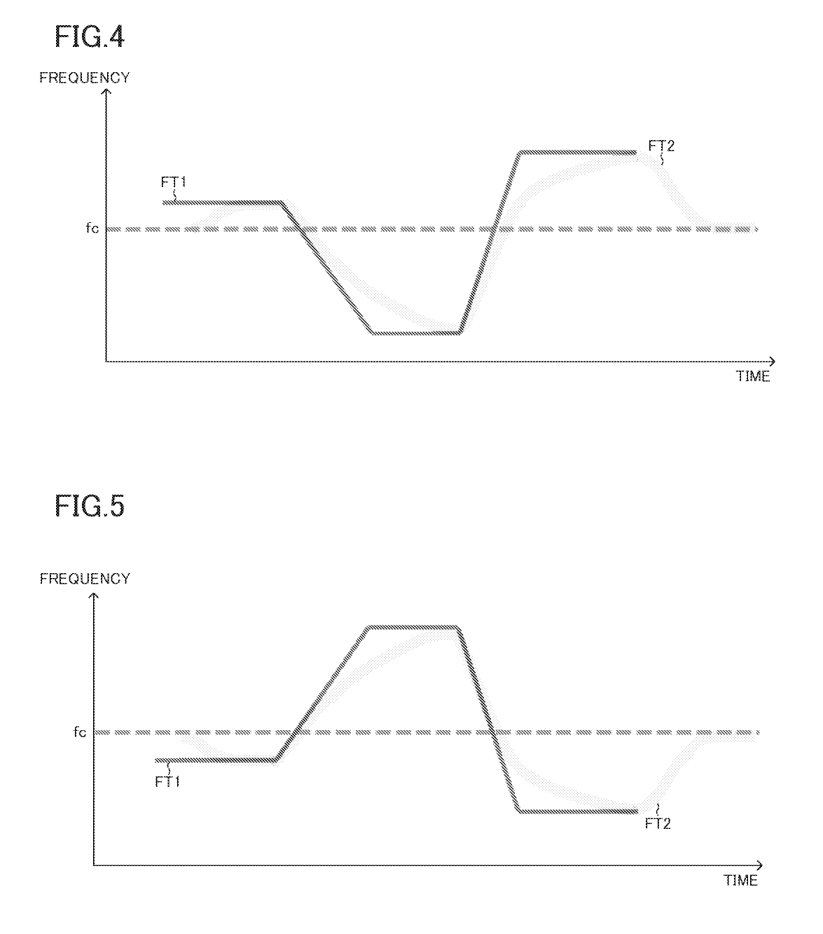

FIGS. 4 to FIG. 8 show examples of the frequency variation patterns provided in the transmission wave signal generation circuit 41. In FIGS. 4 to FIG. 8, the horizontal axis represents time and the vertical axis represents frequency. FIGS. 4 to FIG.8 depict the frequency transition FT1 of the transmission wave signal and the oscillation frequency transition FT2 of the ultrasonic oscillation element 2. As shown in FIGS. 4 to FIG. 8, for a short while after the transmission wave signal ceases, the ultrasonic oscillation element 2 keeps oscillating, that is, reverberation occurs.

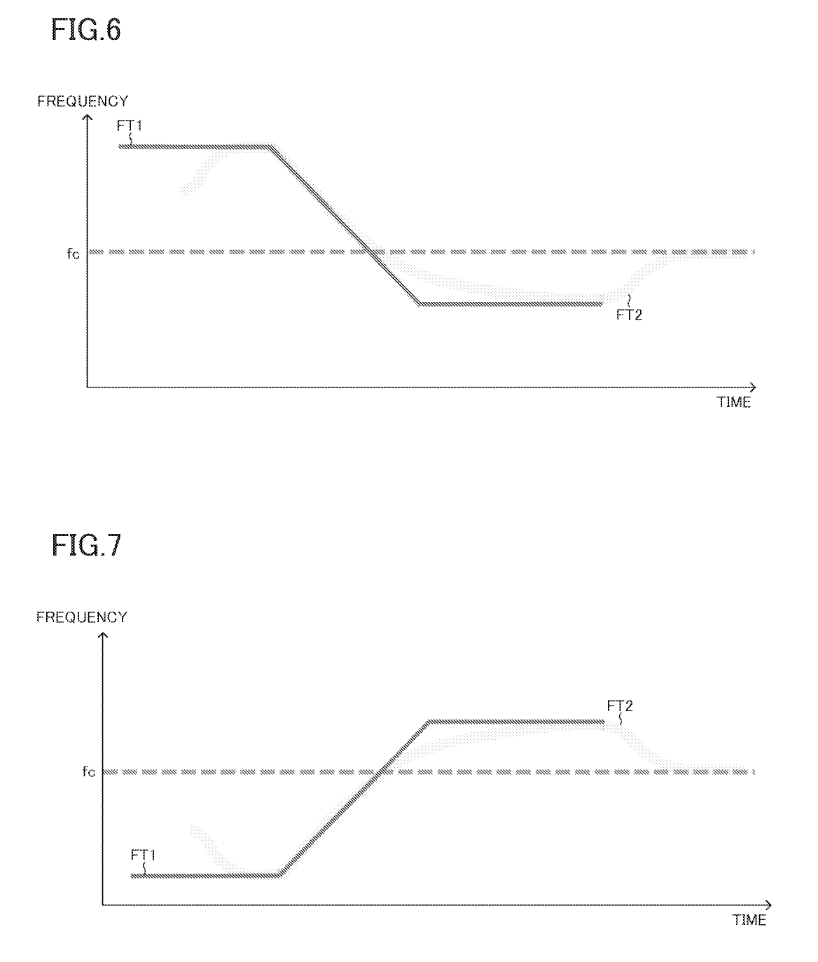

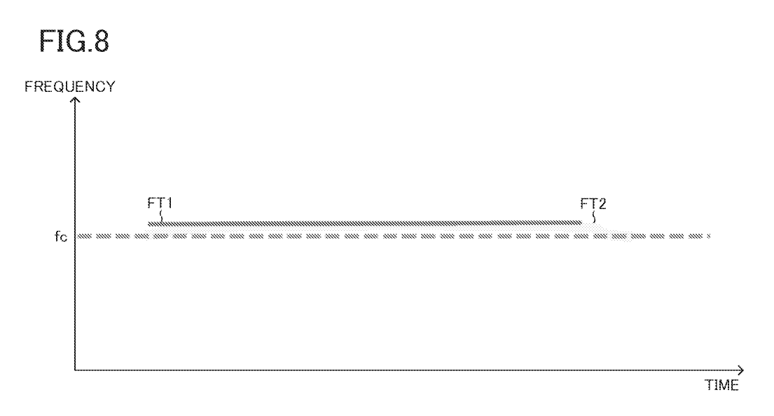

The first pattern shown in FIG. 4 and the second pattern shown in FIG. 5 are examples of patterns in which transitions occur in the order of the initial frequency f0, the first frequency fl, and the second frequency f2. The third pattern shown in FIG. 6, the fourth pattern shown in FIG. 7, and the fifth pattern shown in FIG. 8 are examples of patterns in which transitions occur but not in the order of the initial frequency f0, the first frequency fl, and the second frequency f2.

### < On-Board Sonars >

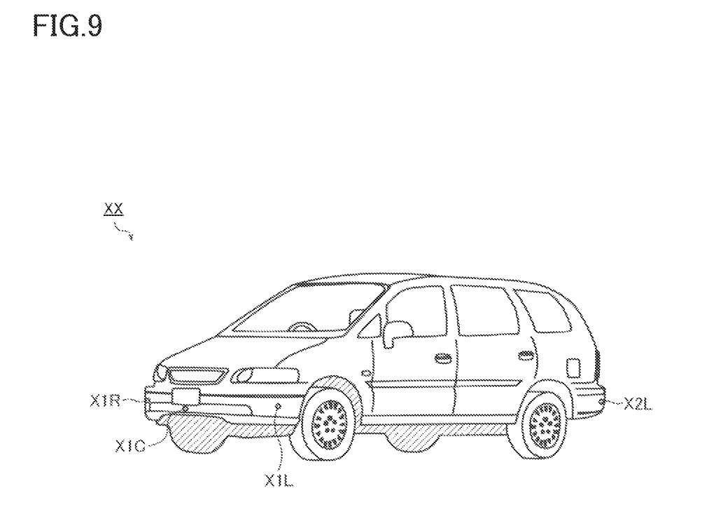

FIG. 9 is an exterior view of a vehicle. The front bumper of the vehicle XX is fitted with front sonars X1(L, R, C) in a left-corner part, a right-corner part, and a middle part of it. Likewise, the rear bumper of the vehicle XX is fitted with back sonars X2(L, R, C) in a left- corner part, a right-corner part, and a middle part of it (for convenience of illustration, the back sonars X2R and X2C are not illustrated).

With the front sonars X1(L, R, C) and the back sonars X2(L, R, C) fitted to it, the vehicle XX can detect the approaching of an object (such as an obstacle, another vehicle, or a passenger) around the vehicle XX or measure the distance to it. This assists the driver in safe driving.

The ultrasonic sensor 1 described previously can be used as each of the front sonars X1(L, R, C) and the back sonars X2(L, R, C) mentioned above.

### < Notes >

The embodiments disclosed herein allow for many modifications wherever necessary without departure from the technical ideas defined in the appended claims. The different embodiments described above can be implemented in any combination unless inconsistent. The embodiment above are merely examples of how what is disclosed herein can be implemented, and the terms used in the present disclosure to refer to various elements are not to be limited to the senses in which they are used in the description of the embodiments.

While in the embodiment above no transformer is provided between the ultrasonic oscillation element 2 and the signal processing device 3, a transformer can be provided between the ultrasonic oscillation element 2 and the signal processing device 3. With a transformer provided between the ultrasonic oscillation element 2 and the signal processing device 3, the boost circuit 43 can be omitted.

### < Overview >

To follow is an overview of what is disclosed herein, of which an example of specific configuration is presented above by way of an embodiment.

According to one aspect of the present disclosure, a driving device (4) includes: a transmission wave signal generation circuit (41) configured to generate a transmission wave signal; and a driving circuit (42) configured to drive an ultrasonic oscillation element based on the transmission wave signal. The driving circuit has: an initial driving sequence in which the driving circuit generates the transmission wave signal at an initial frequency; a first transition sequence in which the driving circuit generates the transmission wave signal during its transition from the initial frequency to a first frequency; and a second transition sequence in which the driving circuit generates the transmission wave signal during its transition from the first frequency to a second frequency. The initial frequency and the second frequency are closer than the first frequency, to the resonance frequency of the ultrasonic oscillation element. The first transition sequence is allotted a time longer than the time allotted to the second transition sequence. (A first configuration.)

In the driving device of the first configuration described above, the driving device can have: a first retention sequence in which the driving device keeps generating the transmission wave signal at the first frequency. The first retention sequence can occur between the first transition sequence and the second transition sequence. (A second configuration.)

In the driving device of the first or second configuration described above, the driving device can have: a second retention sequence in which the driving device keeps generating the transmission wave signal at the second frequency. The second retention sequence can occur after the second transition sequence. (A third configuration.)

The driving device of any of the first to third configurations described above can further include a boost circuit configured to boost a voltage fed to it to generate a supply voltage for the driving circuit. (A fourth configuration.)

In the driving device of any of the first to fourth configurations described above, the driving circuit can be configured to reduce the driving power immediately before starting the first transition sequence. (A fifth configuration.)

In the driving device of the fifth configuration described above, the driving circuit can be configured to reduce the duty of the driving signal fed to the ultrasonic oscillation element immediately before starting the first transition sequence. (A sixth configuration.)

In the driving device of any of the first to sixth configurations described above, the driving circuit can be configured to reduce the driving power immediately before starting the second transition sequence. (A seventh configuration.)

In the driving device of the seventh configuration described above, the driving circuit can be configured to reduce the duty of the driving signal fed to the ultrasonic oscillation element immediately before starting the second transition sequence. (An eighth configuration.)

According to another aspect of the present disclosure, a signal processing device (3) includes: the driving device of any of the first to eighth configurations described above; a reception circuit (5) configured to generate a reception signal based on a reflection wave which is the ultrasonic wave emitted from the ultrasonic oscillation element and reflected from an object; and a discrimination circuit (6) configured to discriminate the reflection wave from the reception signal. (A ninth configuration.)

In the signal processing device of the ninth configuration described above, the transmission wave signal generation circuit can have a plurality of frequency variation patterns for the transmission wave signal. The plurality of frequency variation patterns can include a pattern in which transitions occur in the order of the initial frequency, the first frequency, and the second frequency. The transmission wave signal generation circuit can select one of the plurality of frequency variation patterns. (A tenth configuration.)

In the signal processing device of the tenth configuration described above, the discrimination circuit can be configured to discriminate the reflection wave by discriminating the frequency variation pattern selected by the transmission wave signal generation circuit from the frequency variation patterns not selected by the transmission wave signal generation circuit. (An eleventh configuration.)

According to yet another aspect of the present disclosure, an ultrasonic sensor (1) includes: the signal processing device of any of the ninth to eleventh configurations described above; and an ultrasonic wave transmission/reception device including the ultrasonic oscillation element. (A twelfth configuration.)

According to a further aspect of the present disclosure, a vehicle (XX) includes: the ultrasonic sensor of the twelfth configuration described above. (A thirteenth configuration.)

What is claimed is:

1. A driving device comprising:
a transmission wave signal generation circuit configured to generate a transmission wave signal;
and a driving circuit configured to drive an ultrasonic oscillation element based on the transmission wave signal,
wherein the driving circuit has: an initial driving sequence in which the driving circuit generates the transmission wave signal at an initial frequency; a first transition sequence in which the driving circuit generates the transmission wave signal during a transition thereof from the initial frequency to a first frequency; and a second transition sequence in which the driving circuit generates the transmission wave signal during a transition thereof from the first frequency to a second frequency, the initial frequency and the second frequency are closer, than the first frequency, to a resonance frequency of the ultrasonic oscillation element, and the first transition sequence is allotted a time longer than a time allotted to the second transition sequence.

2. The driving device according to claim 1, wherein the driving device has: a first retention sequence in which the driving device keeps generating the transmission wave signal at the first frequency, and the first retention sequence occurs between the first transition sequence and the second transition sequence.

3. The driving device according to claim 1, wherein the driving device has: a second retention sequence in which the driving device keeps generating the transmission wave signal at the second frequency, and the second retention sequence occurs after the second transition sequence.

4. The driving device according to claim 1, further comprising a boost circuit configured to boost a voltage fed thereto to generate a supply voltage for the driving circuit.

5. The driving device according to claim 1, wherein the driving circuit is configured to reduce driving power immediately before starting the first transition sequence.

6. The driving device according to claim 5, wherein the driving circuit is configured to reduce a duty of the driving signal fed to the ultrasonic oscillation element immediately before starting the first transition sequence.

7. The driving device according to claim 1, wherein the driving circuit is configured to reduce driving power immediately before starting the second transition sequence.

8. The driving device according to claim 7, wherein the driving circuit is configured to reduce a duty of the driving signal fed to the ultrasonic oscillation element immediately before starting the second transition sequence.

9. A signal processing device comprising: the driving device according to claim 1;
a reception circuit configured to generate a reception signal based on a reflection wave which is an ultrasonic wave emitted from the ultrasonic oscillation element and reflected from an object;
and
a discrimination circuit configured to discriminate the reflection wave from the reception signal.

10. The signal processing device according to claim 9, wherein the transmission wave signal generation circuit has a plurality of frequency variation patterns for the transmission wave signal,
the plurality of frequency variation patterns include a pattern in which transitions occur in an order of the initial frequency, the first frequency, and the second frequency, and the transmission wave signal generation circuit selects one of the plurality of frequency variation patterns.

11. The signal processing device according to claim 10, wherein the discrimination circuit is configured to discriminate the reflection wave by discriminating the frequency variation pattern selected by the transmission wave signal generation circuit from the frequency variation patterns not selected by the transmission wave signal generation circuit.

12. An ultrasonic sensor comprising: the signal processing device according to claim 9; and an ultrasonic wave transmission/reception device including the ultrasonic oscillation element.

13. A vehicle comprising: the ultrasonic sensor according to claim 12.
